(19) United States
(12) Patent Application Publication
(10) Pub. No.: US 2004/0090910 A1
(43) Pub. Date: May 13, 2004

(54) Multi-terminal differential protection system

(75) Inventor: Janusz Dzieduszko, Raleigh, NC (US)

Correspondence Address: Michael M. Rickin, Esq., ABB Inc., Legal Department - 4U6, 29801 Euclid Avenue, Wickliffe, OH, 44092-1832, US

(73) Assignee: ABB Inc.

(21) Appl. No.: 10/292,653

(22) Filed: Nov. 12, 2002

(51) Int. Cl. H04L 12/26

(52) U.S. Cl. 370/216; 370/408

(57) ABSTRACT

A multi-terminal electrical differential line protection system wherein each of the terminals had a receiver and a transmitter and the receiver of each terminal is connected to the transmitter of an adjacent terminal to provide a unidirectional data communications link between all of the terminals in a ring on which communications between all of the terminals is in a first direction. Each of the terminals may also have an additional receiver and a transmitter and the additional receiver of each terminal is connected to the additional transmitter of an adjacent terminal to provide a unidirectional data communications link between all of the terminals on another ring on which the direction of communication is opposite the first direction.

### 1. FIELD OF THE INVENTION

This invention relates to the field of electrical fault protection systems and more particularly to multi-terminal differential line protection systems.

### 2. DESCRIPTION OF THE PRIOR ART

Electrical differential protection systems are used frequently to protect components in electrical power systems. Generally, differential protection systems operate by comparing electrical quantities (e.g., current) at inputs and outputs of the protected components. For example, in electrical power transmission systems, differential protection systems detect faults that occur on the high-voltage transmission lines by comparing electrical quantities measured at each of the terminals of the transmission line. By evaluating the compared quantities, the differential protection system may act to isolate the faulted element of the high-voltage transmission line.

One such differential protection system, called current differential protection, uses a current differential to determine whether an interruptible fault has occurred. Current differential protection systems operate under the principles of Kirchoff's Current Law, well known to those skilled in the art. Kirchoff's Current Law posits that the algebraic sum of the currents in all branches that converge in a common node is equal to zero. Therefore, applying this law to an electrical transmission system having high-voltage lines the vectorial sum of currents on each terminal of the line is zero, under normal no-fault conditions.

On the other hand, when a fault occurs on any one of the high-voltage lines, a non-zero current sum will be present. Depending upon the magnitude of the current value and a predetermined “interrupt” threshold, the current differential protection system may isolate the faulted section of the high-voltage line from the rest of the system.

The simplest and most commonly used line configuration is two terminal. Due to various economic and environmental constraints multi-terminal configurations such as three, four, five and more terminals are encountered. Historically the multi-terminal differential protection system was limited to three terminals having the relatively simple data communication links described below in connection with FIGS. 2 and 3. A need for more terminals, that is, four or five and higher, arose quite recently due to economic, space and environmental constraints. These multi-terminal configurations are especially widespread in lower voltage, subtransmission and distribution systems.

Examples of two, three, four and five terminal configurations are shown in FIGS. 1a, 1b, 1c and 1d, respectively. FIG. 1a shows terminals 10 and 12 connected by line 14. FIG. 1b shows terminals 16, 18 and 20 connected by line 22. FIG. 1c shows terminals 24, 26, 28 and 30 connected by line 32. FIG. 1d shows terminals 34, 36, 38, 40 and 42 connected by line 44.

As is described in more detail below the data communication links presently in use in such multi-terminal differential protection systems have various drawbacks. The system of the present invention solves those drawbacks.

There have been attempts to solve the drawbacks in the prior art configurations. One such solution is described in published PCT applications WO 01/43256 and WO 01/43257 both of which are entitled “Differential Protective Method.” The system shown therein which is concerned with charge measurement and comparison has four charge measuring devices 100-103-106-109 which are linked to each other. The link between devices 100 and 109 is unidirectional and the links between devices 100-103-106-109 are bidirectional. Devices 100 and 109 appear to be master devices. There is not any provision for communication redundancy.

Another such solution is described in published Japanese patent application No. 2000-228821 entitled “Optical PCM Current Differential Relay System.” The system has stations A, B, C, D and E and the links between these stations are only bidirectional. There is not any provision for communication redundancy. The problem solved by the system is the dynamic change of the protective relay setting following a fault on the transmission line.

### SUMMARY OF THE INVENTION

A method for obtaining differential protection in an electrical power system. The method includes providing three or more terminals, each of the terminals having a transmitter and receiver; and connecting the receiver of each of the three or more terminals to the transmitter of an adjacent one of the three or more terminals to thereby provide a unidirectional data communication link between all of the three or more terminals in a ring so that data communications between all of the three or more terminals is in a first direction around the ring.

An electrical differential line protection system that includes three or more terminals, each of the terminals comprising a receiver and a transmitter; and a ring connecting a receiver of each of the three or more terminals to a transmitter of an adjacent one of the three or more terminals to thereby provide a unidirectional data communication link between all of the three or more terminals so that data communication between all of the three or more terminals around the ring is in a first direction.

### DESCRIPTION OF THE DRAWING

FIGS. 1a, 1b, 1c and 1d show two, three, four and five terminal configurations, respectively, for a multi-terminal differential protection system.

FIG. 2 shows a three terminal differential protection system in the master-master configuration and the data communication used therein.

FIG. 3 shows a three terminal differential protection system in the master-servant configuration and the data communication used therein.

FIG. 4 shows a four terminal differential protection system in the master-master configuration and the data communication used therein.

FIG. 5 shows a four terminal differential protection system in the master-servant configuration and the data communication used therein.

FIG. 6 shows the architecture for the multi-terminal differential protection system of the present invention.

FIG. 7 shows a redundant architecture for the system of FIG. 6.

FIG. 8 shows the system of FIG. 7 with a simple communication link failure.

FIG. 9 shows the system of FIG. 7 with a communication link failure in the redundant rings.

FIG. 10 shows a schematic for the data communication arrangement in each terminal in the system of the present invention.

FIG. 11 shows the time slot assignment for each terminal.

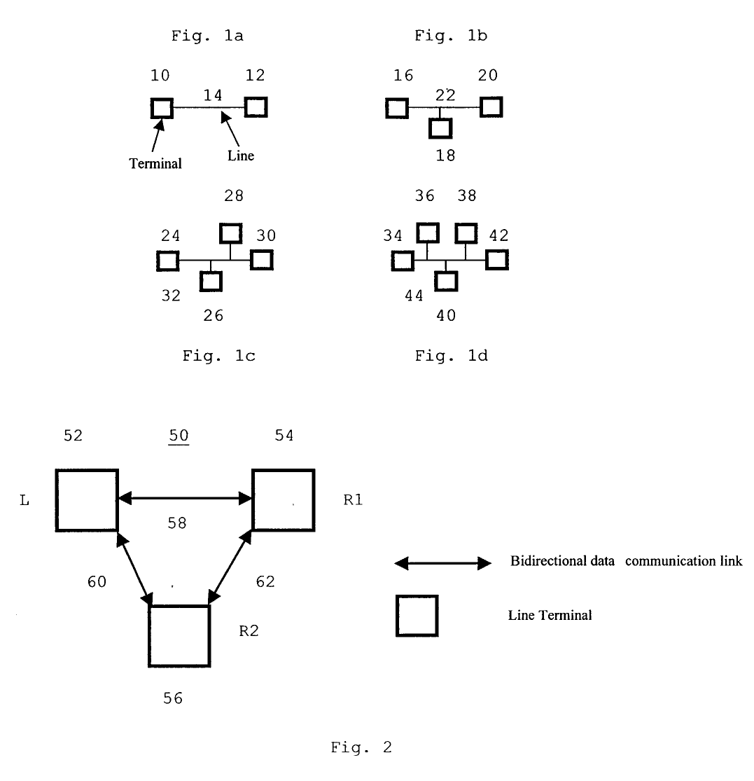

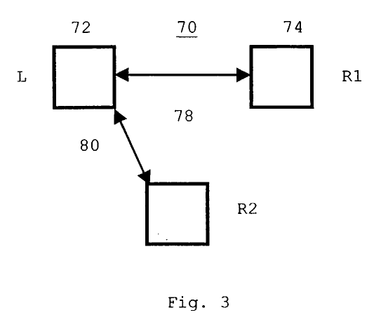

### DESCRIPTION OF THE PREFERRED EMBODIMENT(S)

As was described above, the algebraic sum of the currents in all of the branches of a multi-terminal differential protection system that converge on a common node must, in accordance with Kirchoff's Current Law, have a zero sum when the system does not have a fault. To determine if that is so the currents must be digitized, computed at each terminal and conveyed to one or more central locations for comparison. Data communication is therefore an essential part of this type of protection system.

The multi-terminal protection system architecture that is in existence today and the communications used therein will now be described for three terminal and four terminal systems.

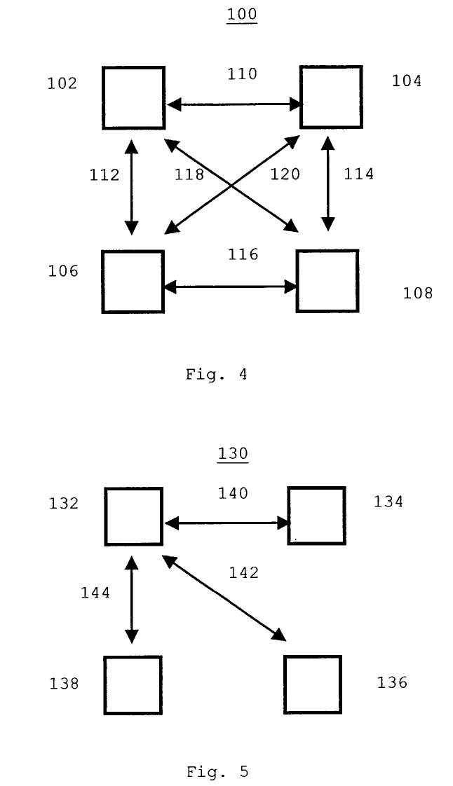

Referring now to FIG. 2, there is shown a three terminal system 50 that is in the master-master, that is, peer, configuration. System 50 has three terminals 52, 54 and 56 that are interconnected to each other by bidirectional (full-duplex) data communication links 58, 60 and 62 where link 58 connects terminals 52 and 54, link 60 connects terminals 52 and 56 and link 62 connects terminals 54 and 56. In this master-master arrangement the protection decisions are performed in each terminal 52, 54 and 56. Each terminal 52, 54 and 56 requires two bidirectional communication ports to communicate with each of the other terminals.

Referring now to FIG. 3, there is shown a three terminal system 70 that is in the master-servant 20 configuration. In this configuration there is a master terminal 72 which is connected to each of two servant terminals 74 and 76. There is a bidirectional communication link 78 between master terminal 72 and servant terminal 74 and another bidirectional communication link 80 between master terminal 72 and servant terminal 76. As compared to the configuration of FIG. 2 there is not any communication between servant terminals 74 and 76.

By deleting the communication link between terminals 74 and 76 those terminals are converted to system servants responsible only for transmitting local phasor data. The protection algorithms are executed only in master terminal 72 and the “transfer trip” command from terminal 72 to terminals 74 and 76 is conveyed via data links 78 and 80, respectively. It should be noted that the trip time for master-servant configuration of FIG. 3 is longer than for master-master arrangement of FIG. 2.

The master terminal 72 requires two bidirectional communication ports to communicate with the servant terminals 74 and 76. The servant terminals 74 and 76 need only one communication port to connect to the master terminal 72.

Referring now to FIG. 4, there is shown a four terminal system 100 that is in the master-master configuration. System 100 has terminals 102, 104, 106 and 108 which are each master terminals. Therefore each of the terminals in system 100 must be in full duplex communication with all of the other terminals in system 100. Thus system has six bidrectional (full-duplex) data communication links 110, 112, 114, 116, 118 and 120 where data link 110 provides full-duplex communications between terminals 102 and 104, data link 112 provides full-duplex communications between terminals 102 and 106, data link 114 provides full-duplex communications between terminals 104 and 108, data link 116 provides full-duplex communications between terminals 106 and 108, data link 118 provides full-duplex communications between terminals 102 and 108, and data link 120 provides full-duplex communications between terminals 104 and 106.

Referring now to FIG. 5, there is shown a four terminal system 130 that is in the master-servant configuration. In this configuration there is a master terminal 132 which is connected to each of three servant terminals 134, 136 and 138. Since in this configuration there is only one master terminal and three servant terminals there only has to be a bidirectional communication link between master terminal 132 and each of servant terminals 134, 136 and 138. Therefore as is shown in FIG. 5 there is a bidirectional communication link 140 between master terminal 132 and servant terminal 134, a bidirectional communication link 142 between master terminal 132 and servant terminal 136 and a bidirectional communication link 144 between master terminal 132 and servant terminal 138.

The examples shown in FIGS. 2, 3, 4 and 5 of master-master and master to servant configurations for three and four terminals with prior art bidirectional data links lead to the following rules regarding the number of bidirectional data links required to interconnect the terminals:

For N terminals arranged in a master-master configuration the number of bidirectional data links is:

the sum of N-1+N-2+N-3 . . .

where N-X (X is any integer) must be a positive number.

For N terminals arranged in a master to servant configuration the number of bidirectional data links is:

N-1.

These rules are summarized in the following table for three, four, five and six terminals arranged in a master-master or master to servant configuration. The table also shows the maximum number of bidirectional communication ports in each terminal.

| | # of Bidirectional | | |
|---|---|---|---|
| | data links | | Maximum # of |
| | Master - | | bidirectional |
| # Of | Master | Master - | communication ports |
| Terminals | (Peer) | Servant | per terminal |
| 3 | 3 | 2 | 2 |
| 4 | 6 | 3 | 3 |
| 5 | 10 | 4 | 4 |
| 6 | 15 | 5 | 5 |

As can be appreciated from the above description of the prior art configurations with bidirectional communications there are major drawbacks to the prior art system architecture:

1. The number of communication links for the Master-Master (Peer) configuration is very high.

2. The Master-Servant configuration, while reducing the number of communication links, suffers from the possibility of a single point of failure (i.e.—the failure of the Master Terminal).

3. Both approaches require a high number of communication ports (all of the terminals for the Master-Master configuration and the Master terminal for Master-Servant version) complicating the terminal design and increasing cost.

4. Adding system redundancy results in an ultra-complicated and extremely expensive configuration.

Referring now to FIG. 6, there is shown the architecture for the multi-terminal protection system 150 of the present invention. System 150 has several terminals T1, T2, T3, T4 . . . Tn where Tn is the terminal number. Each terminal has a communication transmitter shown in FIG. 6 by X, and a communication receiver shown in FIG. 6 by R. Each terminal also has a unidirectional data communication link as shown by the arrow in FIG. 6 which are all linked together in a ring 152. Thus system 150 is known as a ring topology.

The architecture of the system 150 of the present invention offers the following benefits as compared to the multi-terminal protection systems of the prior art:

1. The configuration is master-master as the data for each of terminals T1, T2, T3, T4 . . . Tn is seen by all of the other terminals.

2. A simple terminal communication design as each terminal needs only one transmitter (X) and receiver (R) regardless of the number of terminals.

3. A small number of unidirectional data links.

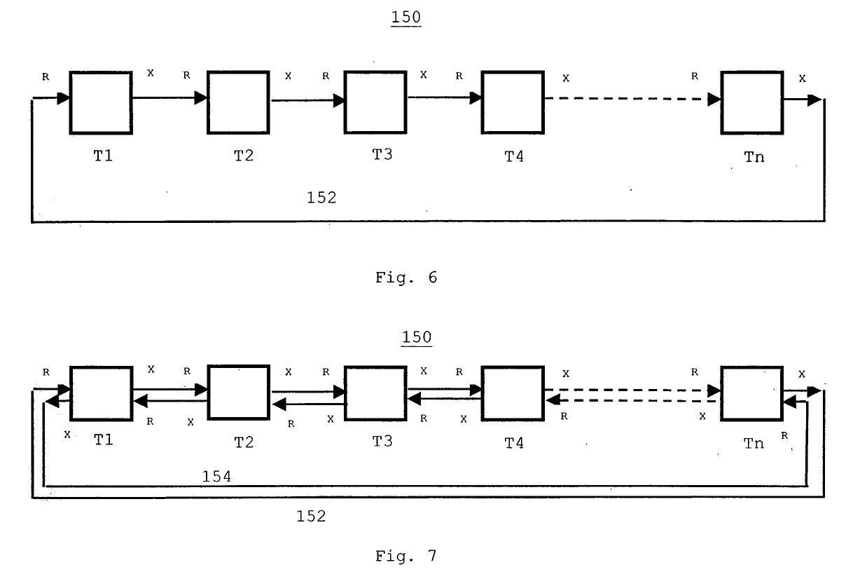

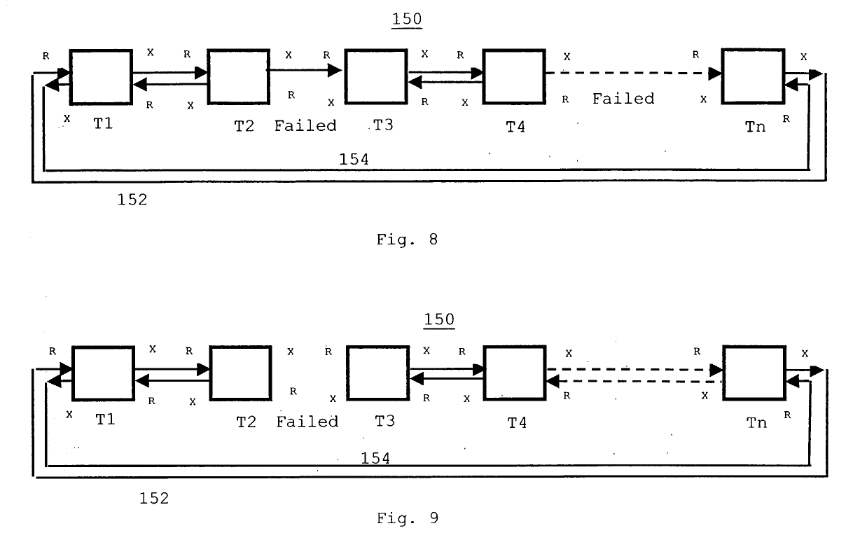

The system 150 can easily be made redundant as shown in FIG. 7 by adding a counter-rotating ring 154 and one additional communication port to each terminal. Thus to achieve full redundancy each terminal needs only two transmitters and two receivers regardless of the number of terminals in system 150.

Referring now to FIG. 8, there is shown system 150 with redundant rings in which a simple communication link failure has occurred in ring 154. A simple link failure occurs when one or more links fail on the same ring. In the system shown in FIG. 8, the redundant link 154 has a communication link failure between terminals T2 and T3, and between terminals T4 and Tn yet the entire system 150 continues to operate in the master-master mode as all of terminals can communicate with each other using ring 152.

Referring now to FIG. 9, there is shown system 150 with redundant rings 152, 154 where a communication failure has occurred in the link between terminals T2 and T3 on both rings 152, 154. Even with such a failure system 150 continues to operate in the master-master mode.

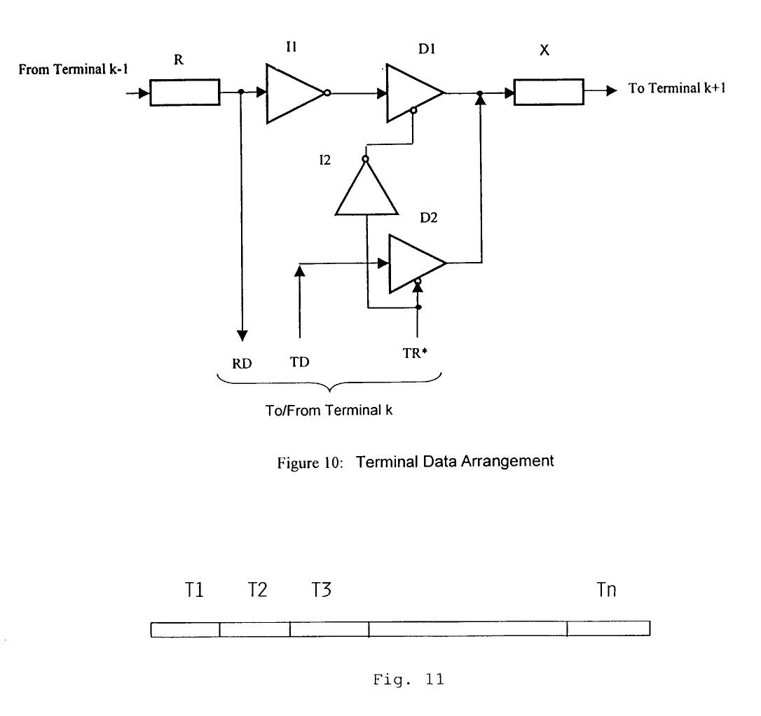

Referring now to FIG. 10, there is shown a schematic for the transmitter X, the receiver R and the internal and external connections of X and R in each terminal of the multi-terminal protection system of the present invention.

FIG. 10 shows these components for terminal k of the system where terminal k receives data from terminal k−1 and transmits data to terminal k+1.

Terminal k includes a receiver R which is connected to the unidirectional data communication link to thereby receive data from the transmitter of terminal k−1. The received data RD is at the output of receiver R tapped off for use internal to terminal k and also passes through an inverter I1 connected to the output of receiver R. Inverter I1 provides pulse width distortion correction as is described in U.S. Pat. No. 5,309,475 the disclosure of which is incorporated herein by reference. The output of inverter I1 is connected to the input of tristate buffer D1.

The data to be transmitted TD from terminal k on the communication link to terminal k+1 and the other terminals connected to the link is applied to the input of tristate buffer D2. Tristate buffer D2 has its enable input connected to the transmit data request signal TR*. The signal TR*, which is low when true, is also connected by inverter I2 to the enable input of tristate buffer D1.

Each terminal has, as is shown in FIG. 11, an assigned time slot and therefore when the signal TR* is true, tristate D2 is enabled and tristate D1 is disabled to thereby allow terminal k to insert transmit data TD in its assigned time slot rather than received data RD. The outputs of tristates D1 and D2 are connected to transmitter X of terminal k and the output of transmitter X is connected to the communication link to terminal k+1.

As was described above, each terminal of the system of the present invention is assigned as is shown in FIG. 11 a time slot for its own data frame transmission. Each terminal's data frame contains start/stop delimiters, addressing, data and error checking/correction.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

What is claimed is:

1. A method for obtaining differential protection in an electrical power system comprising:
providing three or more terminals, each of said terminals having a transmitter and receiver; and
connecting said receiver of each of said three or more terminals to the transmitter of an adjacent one of said three or more terminals to thereby provide a unidirectional data communication link between all of said three or more terminals in a ring so that data communications between all of said three or more terminals is in a first direction around said ring.

2. The method of claim 1 further comprising assigning a unique time slot to each of said three or more terminals for transmitting date on said ring.

3. The method of claim 1 further comprising:
adding another receiver and transmitter to each of said three or more terminals; and
connecting said another receiver of each of said three or more terminals to the another transmitter of an adjacent one or said three or more terminals to thereby provide another unidirectional data communication link between all of said three or more terminals in another ring in a manner such that communications between all of said three or more terminals on said another link is in a direction opposite to said first direction.

4. The method of claim 3 further comprising assigning a unique time slot to each of said three or more terminals for transmitting data on each of said rings.

5. An electrical differential line protection system comprising:
three or more terminals, each of said terminals comprising a receiver and a transmitter; and
a ring connecting a receiver of each of said three or more terminals to a transmitter of an adjacent one of said three or more terminals to thereby provide a unidirectional data communication link between all of said three or more terminals so that data communication between all of said three or more terminals around said ring is in a first direction.

6. The system of claim 5 wherein each of said three or more terminals is assigned a unique time slot for transmitting data on said ring.

7. The system of claim 5 wherein each of said three or more terminals further comprises another receiver and transmitter and further comprising another ring connecting all of another receiver of each of said three or more terminals to a transmitter of an adjacent one of said three or more terminals to thereby provide another unidirectional data communication link between said three or more terminals so that communication around said another ring between said three or more terminals is in a direction opposite to said first direction.

8. The system of claim 7 wherein each of said three or more terminals is assigned a unique time slot for transmitting data on each of said rings.
